(19) United States
(12) Patent Application Publication
(10) Pub. No.: US 2016/0064941 A1
(43) Pub. Date: Mar. 3, 2016

(54) METHOD FOR MANAGING THE ELECTRICITY CONSUMPTION OF AN ELECTRICAL NETWORK

(71) Applicant: COMMISSARIAT A L'ENERGIE ATOMIQUE ET AUX ENERGIES ALTERNATIVES, Paris (FR)

(72) Inventor: Quoc-Tuan Tran, Gieres (FR)

(73) Assignee: COMMISSARIAT A L'ENERGIE ATOMIQUE ET AUX ENERGIES ALTERNATIVES, Paris (FR)

(21) Appl. No.: 14/834,815

(22) Filed: Aug. 25, 2015

(30) Foreign Application Priority Data
Aug. 26, 2014 (FR) 1457984

(51) Int. Cl. H02J 4/00; G06N 5/04; G05B 13/02

(52) U.S. Cl. CPC H02J 4/00; G05B 13/021; G06N 5/048

(57) ABSTRACT

A set of consuming entities (E1, . . . , Ei, . . . EN) each equipped with a thermal installation (Ch1, . . . , ChN) consuming electricity to regulate a temperature of the entity is linked to the electrical network. Each consuming entity implements for a given instant: (a) determining a first datum representative of a power deviation between the electrical power consumed by the set of consuming entities and a setpoint electrical power; (b) determining a second datum representative of a temperature deviation between a measurement of the regulated temperature of said entity and a reference temperature specific to said entity; (c) determining a power regulation coefficient for said entity from the first power deviation datum and from the second temperature deviation datum; (d) controlling a reduction of the power consumed by said entity as a function of the determined regulation coefficient.

### BACKGROUND OF THE INVENTION

The invention relates to a method for regulating the electrical consumption of an electrical network and a regulation device intended to be installed with an electricity consumer.

An electrical network makes it possible to convey electrical energy from electricity production centres to electricity consumers. It must maintain a balance between the production and the consumption and, by dynamic management, ensure the stability of the production-transport-consumption chain.

In a given geographic region, the consumption of electricity is sensitive to the outdoor temperature. For example, in France, in winter, the electrical consumption increases overall, because of an increased electrical consumption of the heating installations in the homes, and consumption peaks occur at certain times of the day, typically during the 6 pm-9 pm time band.

There are currently various solutions for managing these consumption peaks:
importing electricity from another country;
producing more electricity by drawing on additional production means (gas, fuel or coal power plants) which generally operate only in periods of high consumption;
reducing the consumption of a certain number of consumers by a process called “erasing consumption”.

These three solutions give equivalent results in terms of service rendered to the consumers and of balance between production and consumption. The first two solutions do, however, present the drawback of increasing pollution and the risk of accidents.

The third solution, based on the erasing of consumption, consists, in the event of imbalance between the production of electricity and the electricity demand of the consumers, in reducing the consumption of at least some of these consumers. For example, with reference to FIG. 1, it is possible to stop, for a short time T_eff, in a synchronized manner, the electrical power supply to the thermal heating installations located in a large number of homes. That makes it possible to reduce the overall electricity consumption of a region or of a country, for the duration of the outage T_eff. In the final analysis, the management of the consumption peaks is thus performed by controlling the electric heating installations. Such a solution proves of great interest. It does, however, present a number of drawbacks. In effect, the momentary stoppage of the thermal installations provokes an overconsumption immediately after the reconnection of these installations for a period T_bounce as represented in FIG. 1. In the final analysis, the energy which would normally have been consumed during the outage period T_eff is entirely consumed immediately after the restarting of the thermal installations for the period T_bounce as represented in FIG. 1. This phenomenon, called “bounce effect”, greatly reduces the benefit of the consumption peak management methods based on erasing. In addition, it can have negative consequences on the electrical network: overloads, unpredicted significant imbalances, even blackout of the network.

### SUMMARY OF THE INVENTION

The present invention aims to improve the situation.

To this end, the invention relates to a method for managing the electricity consumption of an electrical network to which is linked a set of consuming entities each equipped with a thermal installation consuming electricity to regulate a temperature of the entity, comprising the following steps, implemented in parallel by each consuming entity for a given instant:
a) determination of a first datum representative of a power deviation between the electrical power consumed by the set of consuming entities and a setpoint electrical power;
b) determination of a second datum representative of a temperature deviation between a measurement of the regulated temperature of said entity and a reference temperature specific to said entity;
c) determination of a power regulation coefficient for said entity from the first power deviation datum and from the second temperature deviation datum;
d) control of a reduction of the power consumed by said entity as a function of the determined regulation coefficient.

The consuming entities can be homes, or more generally buildings, equipped with a thermal installation, for example electric heating. Each consuming entity has a preconfigured reference temperature. This reference temperature is specific to the entity and corresponds to a level of thermal comfort desired by the entity.

The invention makes it possible to reduce the overall consumed power, by limiting the power consumed by the thermal installation in each consuming entity, in a self-adaptive and independent manner, without authoritarian disconnection of the thermal installation. Furthermore, the invention requires neither the transmission of a significant quantity of data, nor the complex processing of data, which are costly operations (for example consumption forecasting, weather forecasting, thermal model of the buildings, etc). The limiting of power on each entity takes account of two parameters. The first parameter is the deviation between the power setpoint imposed by the network (that is to say, the reference power desired by the network and constituting a maximum power not to be exceeded) and the overall power actually consumed, or at the very least demanded, by the set of consuming entities. The second parameter is the deviation between the reference temperature of the entity and the real temperature measured in the entity. This temperature deviation makes it possible to characterize any offset between the thermal comfort desired by the entity and the real thermal comfort in the entity. The inclusion of these two parameters enables each entity to limit the electrical consumption of its thermal installation, without the latter being cut off, so as to contribute to the overall effort to reduce consumption and avoid a consumption peak, while maintaining a thermal comfort close to that desired by this entity. In the final analysis, the invention makes it possible to limit the overall electricity consumption peaks while best preserving the thermal comfort of the consuming entities.

Advantageously, the determination of the regulation coefficient is adapted for the power reduction of each consuming entity, determined from the regulation coefficient, to be commensurately greater when said temperature deviation of the consuming entity is low.

Thus, the closer the measured temperature of the consuming entity considered is to its setpoint temperature, the more this consuming entity will reduce its individual consumption and contribute to the overall power reduction. Conversely, an entity whose measured temperature is a long way from its reference temperature will contribute less to the effort to reduce demanded power. Thus, the entities having a thermal comfort lower than that desired contribute less to the overall reduction of consumption than the entities that have a thermal comfort close or equal to that desired.

Also advantageously, the steps a) to d) are reiterated until the electrical power demanded by the set of consuming entities is less than or equal to the setpoint power.

The looped repetition of the steps a) to d) makes it possible to reduce the overall consumption in a best fit manner so as to best preserve the thermal comfort for the consuming entities without the need for thermal models of the buildings and/or forecast information (consumption and weather).

In a particular embodiment, the execution of the steps a) to d) is triggered on reception of a command from the network, notably a command containing a setpoint power.

Advantageously, each entity receives, in real time, the overall power consumed by the set of consuming entities, from the network.

In a particular embodiment, the regulation coefficient is determined by a computation method based on fuzzy logic.

Advantageously, the determination of the regulation coefficient comprises
a first substep of fuzzification during which the first power deviation datum is translated into degree(s) of membership (or belonging) to one or more subsets which characterize a first component of contribution of the entity to a reduction of overall power consumption;
a second substep of fuzzification during which the second temperature deviation datum is translated into degree(s) of membership to one or more subsets which characterize a second component of contribution of the entity to the reduction of overall power consumption;
a third substep of inference during which, from the results of the first and second substeps of fuzzification and from predefined inference rules, at least one degree of membership to one or more subsets which characterize the power regulation coefficient is determined;
a fourth substep of defuzzification during which a numeric regulation coefficient value is determined from the results of the substep of defuzzification.

The consuming entities can be equipped with at least one of the thermal installations from the group comprising an electric heating installation, an electric water heater and an air conditioning installation.

The temperature of the entity regulated by the thermal installation can be an atmospheric temperature in a building or a heated water temperature.

The invention relates also to a device for regulating the electricity consumption of a consuming entity linked to an electrical network, adapted to implement the method as previously defined, said entity comprising a thermal installation consuming electricity and intended to regulate a temperature of the entity and membership to a set of consuming entities, comprising:
a first communication module adapted to receive an overall electrical power consumed by said set of entities and a setpoint power, from the electrical network;
a second communication module adapted to receive a temperature of the entity measured at a given instant;
a module for determining a first datum representative of a deviation between the overall electrical power consumed at a given instant and a setpoint electrical power;
a module for determining a second datum representative of a temperature deviation between a measured temperature of the entity for the instant considered and a reference temperature of the entity;
a module for determining a power regulation coefficient for the entity from the first power deviation datum and the second temperature deviation datum;
a control module intended to control a reduction of the power consumed by the thermal installation of the consuming entity dependent on the determined regulation coefficient.

The invention relates also to a computer program comprising program code instructions for the execution of the steps of the method when said program is run on a computer.

### BRIEF DESCRIPTION OF THE DRAWINGS

The invention will be better understood from the following description of a particular embodiment of the method for managing the electricity consumption of an electrical network and of a particular exemplary embodiment of an associated regulation device, with reference to the attached drawings in which:

FIG. 1 is a schematic depiction of a bounce effect in a prior art electricity consumption management system;

FIG. 2 schematically represents an electrical network and a set of electricity-consuming entities connected to the network;

FIG. 3 represents the main steps in computing a power regulation coefficient of a consuming entity, according to a particular embodiment of the method of the invention;

FIG. 4 represents fuzzy logic membership functions relative to a power deviation variable;

FIG. 5 represents fuzzy logic membership functions relative to a temperature deviation variable;

FIG. 6 represents fuzzy logic membership functions relative to a power regulation coefficient;

FIG. 7A represents a simplified inference table, according to a particular exemplary embodiment;

FIG. 7B represents a 3D inference surface, according to the particular embodiment, representing, in three dimensions, the regulation coefficient as a function of the temperature deviation and power deviation variables;

FIG. 7C represents trend curves of the regulation coefficient as a function of the temperature deviation, for two different demanded electrical consumption reduction values;

FIG. 8 schematically represents the different steps in determining a power reduction to be applied implemented by a consuming entity, according to a particular embodiment of the invention;

FIGS. 9 and 10 respectively represent the time trend of the overall power consumed by the set of consuming entities of FIG. 2 and the time trend of the indoor atmospheric temperature of one of the consuming entities of the set, without the invention;

FIGS. 11 and 12 respectively represent the time trend of the overall power consumed by the set of consuming entities of FIG. 2 and the time trend of the indoor atmospheric temperature of one of the consuming entities of the set, with the invention;

FIG. 13 represents a flow diagram of the steps of the method for managing the electricity consumption of an electrical network, according to a particular embodiment of the invention;

FIG. 14 represents a functional block diagram of a device for regulating the electricity consumption of a consuming entity linked to the electrical network, intended to implement the method of FIG. 13.

### DETAILED DESCRIPTION OF PARTICULAR EMBODIMENTS

The method of the invention aims to regulate the electricity consumption of an electrical network 1 to which electricity consumers are linked.

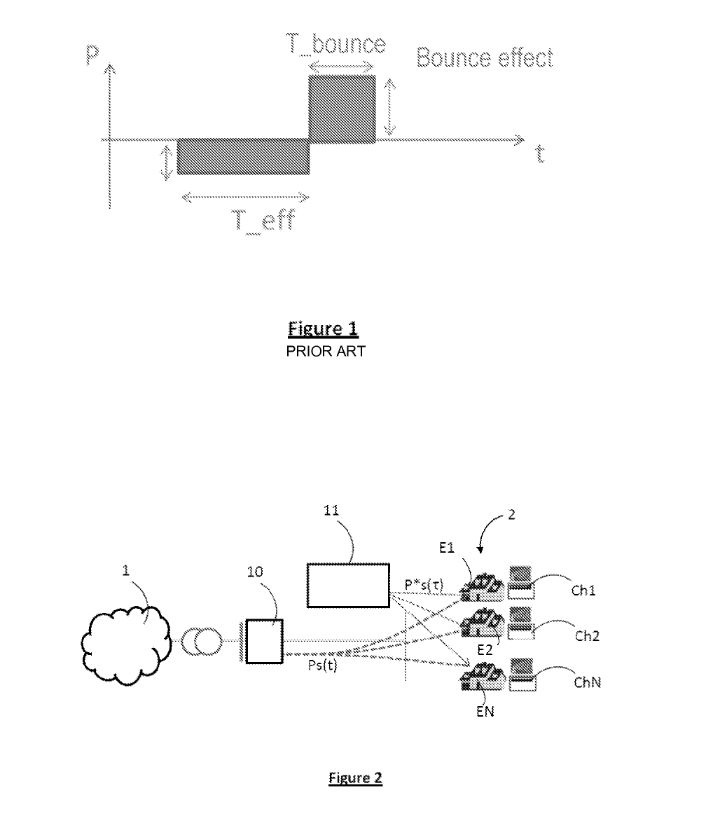

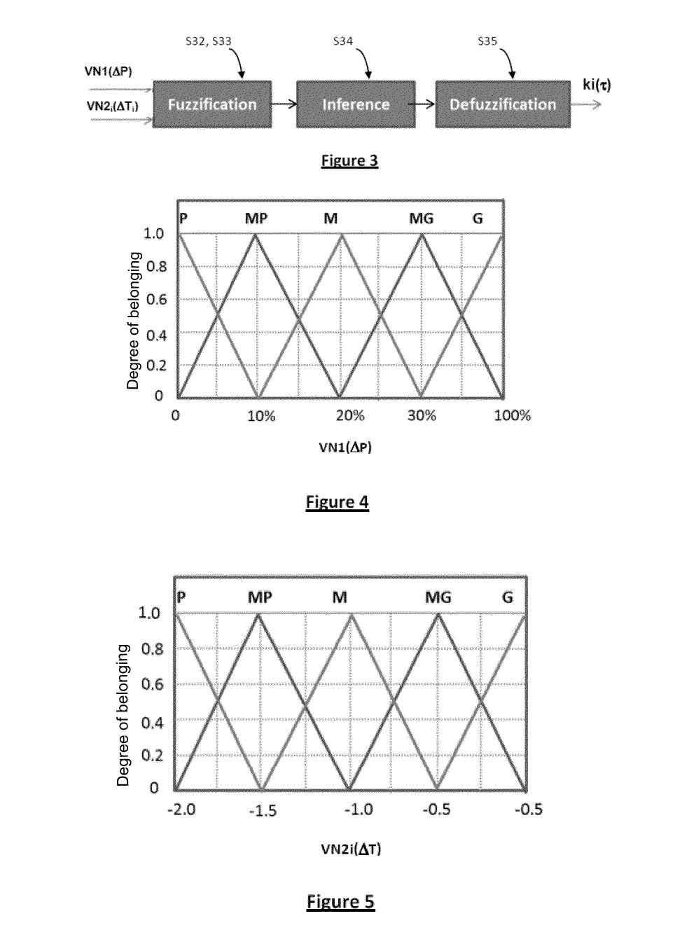

FIG. 2 shows a set 2 of electricity-consuming entities E1, E2, . . . , Ei, . . . , EN linked to the electrical network 1. For example, the set 2 comprises homes located in a given geographic area, such as a district of a town. Each entity Ei (with i=1, . . . , N) is equipped with a thermal installation consuming electricity which can be, in a nonexhaustive manner, electric heating, a water heater or an air conditioning installation.

In the particular example described here, each entity Ei is equipped with an electric heating installation Chi (with i=1, . . . , N) intended to heat the indoor air of the entity, a device for controlling the heating (not represented) and a thermal sensor intended to measure the temperature of the air inside the entity. Each heating installation Chi has a predefined nominal power (that is to say, a power delivered in the nominal conditions of use supplied by the manufacturer). The control device is configured with a reference temperature. This reference temperature defines a level of thermal comfort desired by the entity Ei. In the particular example described here, the reference temperature is a maximum temperature desired in the entity Ei and here denoted Tset_maxᵢ. The control of the heating makes it possible to regulate the temperature in such a way that it fluctuates slightly just below this maximum temperature. The reference temperature could be an average temperature.

The control module incorporates a first module for communication with the electrical network 1 and a second module for communication with the thermal sensor.

The first communication module is intended to receive:
data relative to the overall power Ps(τ) consumed by the set of consuming entities Ei (with i=1, . . . , N), measured and transmitted in real time (t) by a device 10 of the network 1, and
data relative to a setpoint power P*s demanded by the network 1 at a given instant τ, transmitted by an aggregator or a manager 11 of the network.

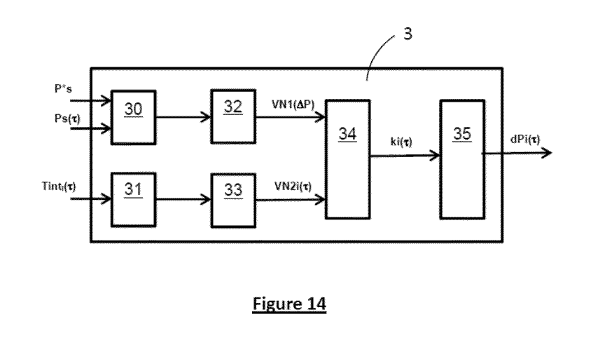

There now follows a description, with reference to FIG. 13, of the steps of the method for managing, or for regulating, the electricity consumption of the electrical network 1 to which the consuming entities E1 to EN are linked.

In a step S0, at an instant τ, the entities E1 to EN receive a command to reduce the consumed electrical power, from the network manager 11. The command here contains the value of a setpoint power P*s. This setpoint power P*s, or reference power, constitutes the maximum overall power that the set of entities E1 to EN is authorized to consume. The command signals to the entities E1 to EN that they have to reduce their individual electrical consumptions to reach an overall consumption less than or equal to P*s. As a variant, the transmitted command could contain any other value representative of this setpoint power P*s, for example a percentage variation of overall power desired by the network 1.

Following the reception of the reduction command (S0), each entity E1 to EN triggers the execution of the regulation steps S1 to S5. The regulation is executed in parallel, self-adaptively and independently, by the different entities E1 to EN, for the instant τ considered.

In a step S1, each entity Ei determines a first numeric variable (or datum) VN1 representative of the power deviation ΔP between the overall electrical power Ps(τ) consumed by the set of consuming entities at the instant τ, or substantially at the instant τ, communicated in real time by the network 1, and the setpoint electrical power P*s ordered by the network manager 11. The variable VN1 is here equal to the difference between the setpoint power P*s and the consumed power Ps(τ), divided by the setpoint power P*s. It is expressed as a percentage. In other words:

$$VN 1 = \frac{P * s - Ps ( τ )}{P * s} \times 100$$

The sign (negative or positive) of VN1 makes it possible to determine if the power has to be reduced or increased.

In parallel, in a step S2, each entity Ei (with i=1, . . . , N) determines a second numeric variable VN2ᵢ representative of a temperature deviation ΔTᵢ which is specific to it. The step S2 comprises a first substep of the measurement of the temperature Tintᵢ(τ) at the instant τ, or substantially a little after this instant τ, of the air inside the entity considered Ei. A second substep of computation is then performed. It consists in computing the temperature deviation ΔTᵢ(τ) between the measured indoor temperature Tintᵢ(τ) and the reference temperature Tset_maxᵢ. This reference temperature Tset_maxᵢ corresponds here to a maximum temperature preconfigured and stored in the control module of the thermal installation. It defines the level of thermal comfort desired by the entity Ei. In the second substep of computation, each entity Ei therefore computes:

VN2ᵢ=ΔTᵢ(τ)=Tintᵢ(τ)−Tset_maxᵢ

When the deviation ΔTᵢ(τ) is strictly positive, this means that the temperature measured inside the entity Ei is higher than the reference temperature Tset_maxᵢ. For example, this occurs when the entity Ei is heated not only by the heating Chi but also by additional heating means. In this case, the control module switches off the thermal installation such that the regulation implemented by the method of the invention is not necessary for that entity.

When the deviation ΔTᵢ(τ) is negative or zero, the method continues. The step S2 is followed by a step S3 of determination of a power regulation coefficient kᵢ(τ), implemented by each entity Ei. This regulation coefficient is representative of the contribution of the entity Ei to the lowering of overall electrical consumption demanded by the network 1. In the particular example described here, it is intended to be multiplied by the nominal electrical power of the thermal installation of the entity Ei in order to determine the scale of the power reduction to be applied by this entity Ei. The regulation coefficient is determined from the first power deviation variable VN1 and the second temperature deviation variable VN2ᵢ. Thus, the regulation coefficient kᵢ(τ), computed for the instant τ and for the consuming entity Ei, depends on the overall quantity of power to be reduced and on the deviation between the real indoor temperature of the entity Ei and the desired comfort temperature (that is to say, the preconfigured reference temperature). Preferably, the determination of the regulation coefficient is adapted for the reduction of power of each consuming entity Ei to be commensurately greater when the temperature deviation ΔTᵢ(τ) of said consuming entity Ei is low as an absolute value.

In the particular exemplary embodiment described here, the coefficient kᵢ(τ) is determined by a computation method based on the fuzzy logic implemented by a fuzzy system. The step S3 comprises the following substeps implemented by each entity Ei:
a first substep of fuzzification S31 during which the first power deviation datum VN1 is translated into degree(s) of membership (or belonging) DA1 to one or more subsets which characterize a first component of contribution of the entity Ei to the reduction of overall power consumption;
a second substep of fuzzification S32 during which the second temperature deviation datum VN2 is translated into degrees of membership DA2 to one or more subsets which characterize a second component of contribution of the entity Ei to the reduction of overall power consumption;
a third substep of inference S33 during which, from the results of the substeps S31 and S32 and predefined inference rules, degrees of membership DA3 to one or more subsets which characterize the power regulation coefficient are determined;
a fourth substep of defuzzification S34 during which a numeric regulation coefficient value, that is to say kᵢ(τ), is determined from the results of the substep S33.

The subsets which each characterize two components of contribution (or of participation) of the entity considered Ei in the lowering of overall consumption here number five. Obviously, the number of subsets could be equal to any other value greater than or equal to 1. Furthermore, the two components of contribution, respectively relative to the power deviation and to the temperature deviation, could be defined by different numbers of subsets. The subsets are respectively defined by linguistic variables. The five subsets of each component of contribution are defined by the following five variables:
“ID” for “small participation”,
“MP” for “medium-small participation”,
“M” for “medium participation”,
“MG” for “medium great participation” and
“G” for “great participation”.

In FIG. 4, the five functions of membership to the five subsets P, MP, M, MG and G have been represented relative to the power deviation (VN1). In this FIG. 4, the power deviation variable VN1, that can vary from 0% to 100%, is represented on the x axis and the degrees of membership to the subsets, between 0 and 1, are represented on the y axis.

In FIG. 5, the five functions of membership to the five subsets P, MP, M, MG and G have been represented relative to the temperature deviation (VN2ᵢ). In this FIG. 5, the temperature deviation variable VN2, varying between −2° C., or any other value lower than −2° C. (for example −3° C.), and −0.5° C., is represented on the x axis and the degrees of membership to the different subsets are represented on the y axis.

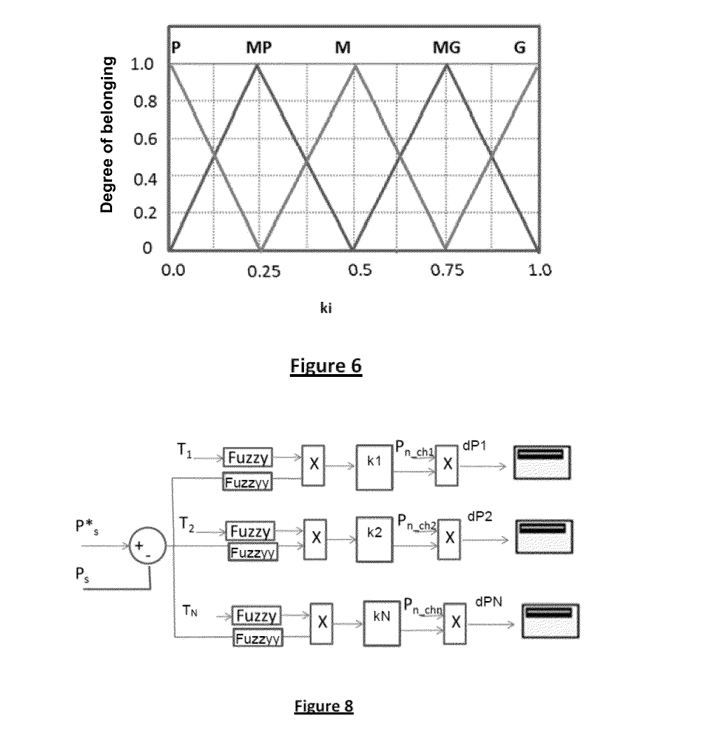

In FIG. 6, the five functions of membership to the five subsets P, MP, M, MG and G have been represented relative to the regulation coefficient kᵢ. In this FIG. 6, the value of the regulation coefficient kᵢ, varying between 0 and 1, is represented on the x axis and the degrees of membership to the different subsets are represented on the y axis.

The functions of membership represented in FIGS. 4 to 6 are predefined when designing the fuzzy system, for the variables VN1, VN2i and kᵢ. The forms of these functions as represented in these FIGS. 4 to 6 are particularly exemplary embodiments, and nonlimiting. It will be possible to envisage using functions of membership that have different forms.

On completion of the substeps S31 and S32, the following data are obtained for each consuming entity Ei:
data of membership to the subsets P, MP, M, MG and G defining a first component of participation, from the power deviation VN1;
data of membership to the subsets P, MP, M, MG and G defining a second component of participation, from the temperature deviation VN2ᵢ specific to the entity Ei.

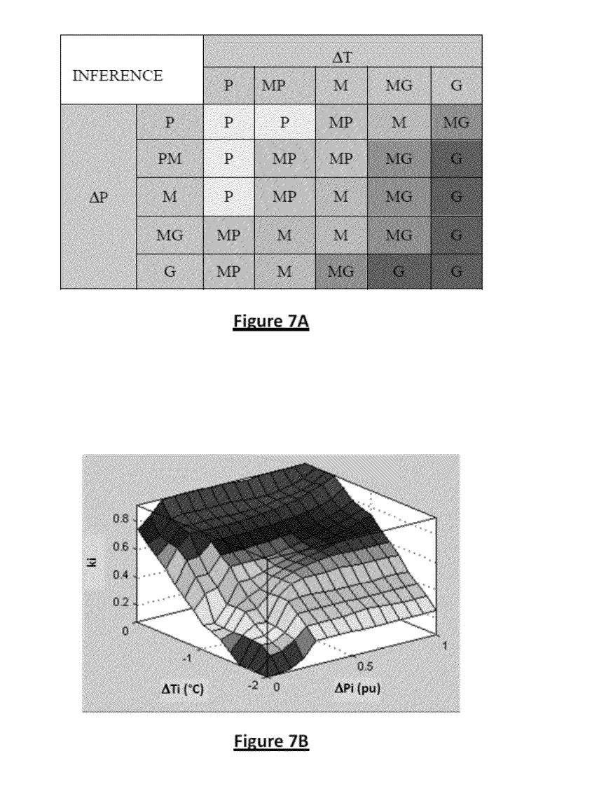

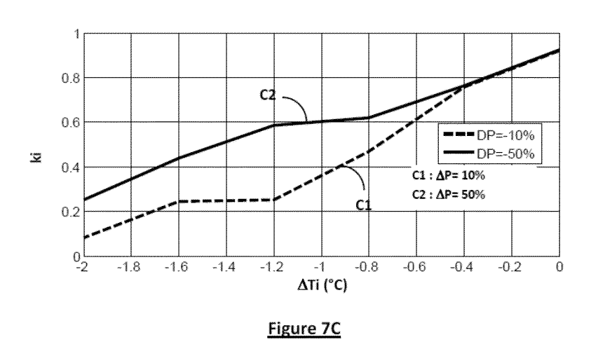

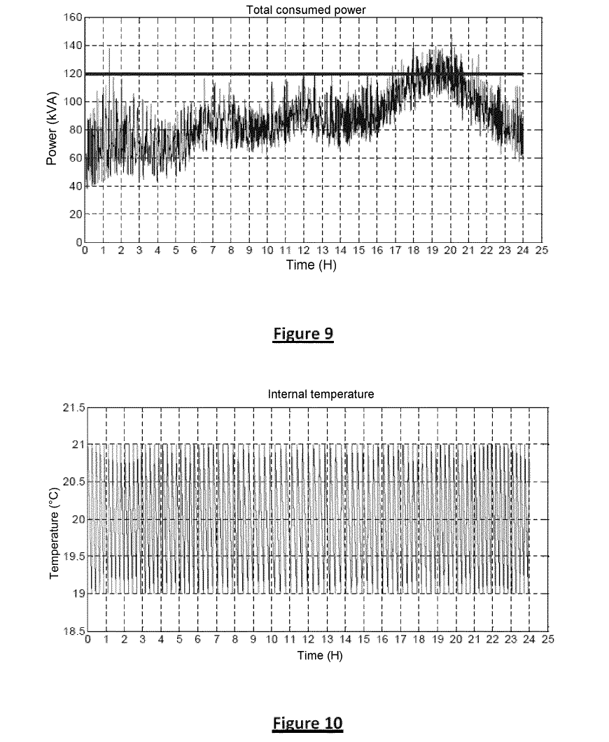

During the inference substep S33, the fuzzy system determines the degrees, or data, of membership of the regulation coefficient kᵢ of the entity Ei from data of membership obtained on completion of the substeps S31 and S32, from predefined inference rules. The table of FIG. 7A represents, in a simplified manner, the inference rules that apply to degrees of membership to the subsets P, MP, M, MG and G equal to 1. Each column corresponds to a subset of temperature deviation and each row corresponds to a subset of power deviation. The cells located at the intersection of a row and of a column provide a resultant subset for the regulation coefficient ki.

The next substep of defuzzification S34 consists in determining a numeric value of the regulation coefficient kᵢ from data of membership determined in the substeps S32 and S33. A regulation coefficient kᵢ(τ) is thus obtained for each entity Ei and for the instant τ.

FIG. 7B is a graphic representation in three dimensions of the regulation coefficient ki as a function of the temperature deviation ΔTi, on the one hand, and of the relative power deviation

$$Δ Pi = \frac{\vert P * s - Ps ( τ ) \vert}{P * s} ,$$

on the other hand. This representation is an inference graph, having, in this case, the form of a surface. This inference surface contains different areas corresponding to the different subsets P, MP, M, MG and G of the coefficient ki.

Based on the temperature deviation ΔTi of each entity Ei, the regulation coefficient ki differs. The Table 1, below, represents different numeric values of the coefficient ki for different numeric temperature deviation values, with a reduction of 10% of the electrical power consumption (ΔPi=0.1). The Table 2, below, represents different numeric values of the coefficient ki for different numeric temperature deviation values, with a reduction of 50% of the electrical power consumption (ΔPi=0.5).

TABLE 1

| ΔPi | ΔTi | ki |
|---|---|---|
| 0.1 | 0 | 0.92 |
| 0.1 | −0.4 | 0.756 |
| 0.1 | −0.8 | 0.466 |
| 0.1 | −1.2 | 0.250 |
| 0.1 | −1.6 | 0.244 |
| 0.1 | −2.0 | 0.08 |

TABLE 2

| ΔPi | ΔTi | k |
|---|---|---|
| 0.5 | 0 | 0.924 |
| 0.5 | −0.4 | 0.761 |
| 0.5 | −0.8 | 0.618 |
| 0.5 | −1.2 | 0.586 |
| 0.5 | −1.6 | 0.437 |
| 0.5 | −2.0 | 0.25 |

FIG. 7C shows:
a first trend curve C1 of the coefficient ki as a function of the temperature deviation ΔTi for a reduction of 10% of the electrical power consumption;
a second trend curve C2 of the coefficient ki as a function of the temperature deviation ΔTi for a reduction of 50% of the electrical power consumption.

This FIG. 7C in the final analysis illustrates the variation of the coefficient ki as a function of a variation of the temperature deviation with two different sensitivities induced by two different power reduction values.

It is thus found that:
an entity which has a greater temperature deviation than that of another entity, has a lower regulation coefficient than that of the other entity and therefore participates less in reducing the power than the other entity;
when the reduction of electrical consumption demanded by the electrical network is greater, the regulation coefficients are higher (the curve C2 is overall located above the curve C1), in other words the power reduction participation of each entity is greater.

In a step S4, each entity Ei computes a scale of power reduction to be applied dPi(τ) by multiplying here the regulation coefficient kᵢ(τ) by the nominal power of the thermal installation, here of the heating, Pn_Chi of the entity Ei, according to the following relation:

dPi(τ)=kᵢ(τ)×Pn_{—}Chi

In a step S5, on a command from the control module, each consuming entity Ei reduces the electrical power consumed by its thermal installation Pchi by the computed reduction dPi(τ).

During a test step S6, at an instant τ′ later than τ, the manager 11 of the network 1 checks whether the overall power Ps(τ′) consumed is less than or equal to the setpoint power P*s. For example, the check S6 can be performed ten or so seconds after the sending S0 of the power reduction setpoint. If the test is positive, the lowerings of power consumption applied by each entity, in a customized manner, have been sufficient to reduce the overall power consumed below or at least to the setpoint P*s. The method is therefore finished (“END” step S7). If the test is negative, the manager 11 transmits a new lowering command to the entities E1 to En, this command again containing the setpoint power P*s. On reception of this new command, the steps S0 to S6 are reiterated for the instant τ′, such that each entity Ei determines a new power reduction value dPi(τ′) and reduces the consumption of its thermal installation in order to obtain the setpoint power P*s.

FIG. 8 shows, in a schematic and simplified manner, the different steps of the method.

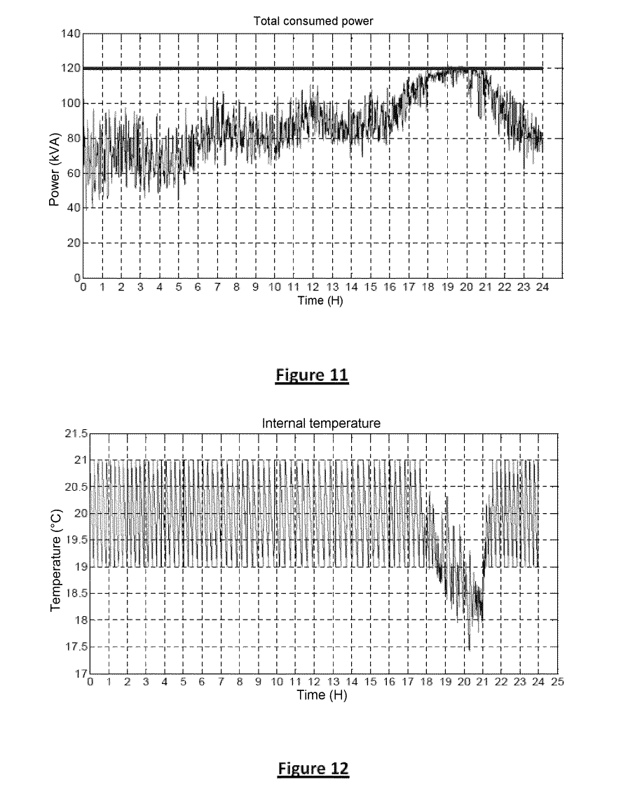

FIGS. 9 and 10 respectively represent the trend of the total electrical power consumed by the set of entities E1 to EN throughout a day and the trend of the temperature of the air inside one of the entities Ei, in the case where the invention is not implemented. In FIG. 9, a consumption peak is observed around the 6 pm-9 pm time band, whereas the indoor atmospheric temperature of the entity Ei varies between 19 and 21° C., which corresponds to the maximum level of thermal comfort configured for this entity.

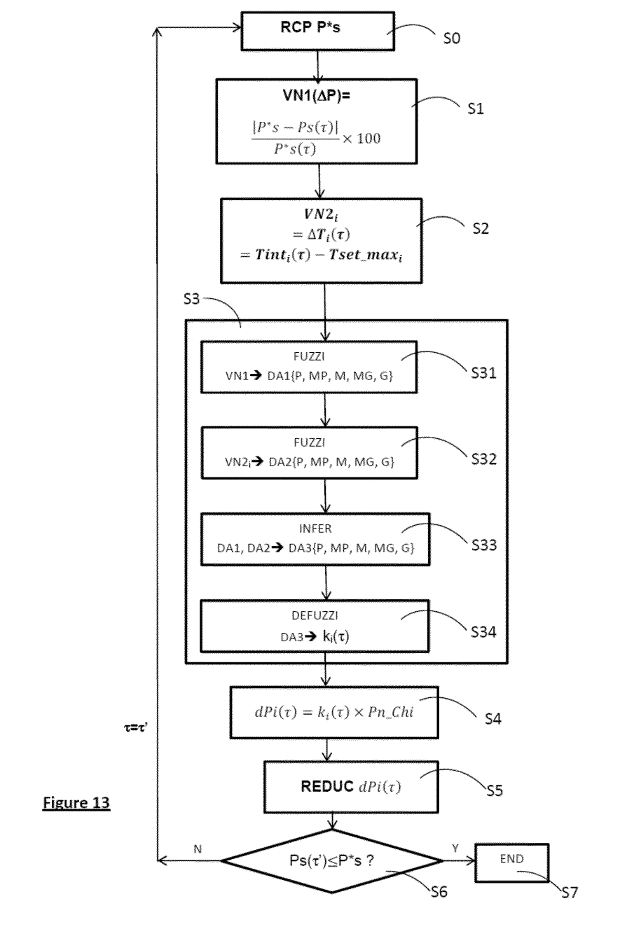

FIGS. 11 and 12 respectively represent the trend of the total electrical power consumed by the set of entities E1 to EN throughout a day and the trend of the temperature of the air inside one of the entities Ei, in the case where the invention is implemented. In FIG. 10, it is observed that the consumption peak of the 6 pm-9 pm time band is erased, the overall consumption not exceeding the maximum power authorized by the network manager 11 (here 120 kVA). In FIG. 12, it can be seen that, during the critical 6 pm-9 pm time band, the indoor atmospheric temperature of the entity Ei decreases slightly and varies between 17.5° C. and 20° C.

The invention relates also to a device for regulating the electricity consumption of a consuming entity Ei. The device is adapted to implement those steps of the method previously described which are implemented by a consuming entity Ei. It is incorporated in or connected to the control module of the thermal installation of the consuming entity Ei.

Referring to FIG. 14, the regulation device 3 comprises
a first communication module 30 adapted to receive an overall electrical power consumed by said set of entities (E1, . . . , EN) and a setpoint power (P*s), from the electrical network (1);
a second communication module 31 adapted to receive a temperature of the entity measured at a given instant;
a module 32 for determining a first datum VN1 representative of a deviation between the overall electrical power consumed Ps(τ) at a given instant τ and a setpoint electrical power P*s,
a module 33 for determining a second datum VN2ᵢ representative of a temperature deviation between a measured temperature of the entity Tintᵢ(τ) for the instant considered τ and a reference temperature of the entity Tset_maxᵢ,
a module 34 for determining a power regulation coefficient kᵢ(τ) for the entity Ei from the first power deviation datum VN1 and the second temperature deviation datum VN2ᵢ,
a control module 35 intended to control a reduction dPi(τ) of the power consumed by the thermal installation of the consuming entity Ei dependant on the determined regulation coefficient kᵢ(τ).

The first and second communication modules 30, 31 can, for example, be connected to the control device of the thermal installation, which itself incorporates a module for communication with the network 1 and a module for communication with the thermal sensor of the entity Ei. As a variant, the communication modules 30 and 31 can be directly linked to the network and to the temperature sensor respectively.

The modules 32 and 33 are designed to implement the steps S1 and S2 respectively.

The module 34 is designed to implement the step S3, in other words the substeps S31 to S34. It incorporates the fuzzy system, previously mentioned, designed to determine the regulation coefficient from power deviation and temperature deviation variables by fuzzy logic.

The control module 35 is intended to implement the step S4.

The modules 32 to 35 are software modules forming a computer program and comprising software instructions to control the implementation of the corresponding method steps, when the modules are executed by a processor. The invention therefore relates also to a computer program comprising program code instructions for the execution of the steps of the method previously described when said program is run on a computer.

1. Method for managing the electricity consumption of an electrical network to which is linked a set of consuming entities each equipped with a respective thermal installation consuming electricity to regulate a temperature of the respective consuming entity, the method comprising the following steps, implemented in parallel by each consuming entity for a given instant:
a) determining a first datum representative of a power deviation between an electrical power consumed by the set of consuming entities and a setpoint electrical power;
b) determining a second datum representative of a temperature deviation between a measurement of the regulated temperature of said consuming entity and a reference temperature specific to said consuming entity;
c) determining a power regulation coefficient for said entity from the first power deviation datum and from the second temperature deviation datum;
d) controlling a reduction of the power consumed by said consuming entity as a function of the determined regulation coefficient.

2. Method according to claim 1, wherein the determination of the power regulation coefficient is adapted for the power reduction of each consuming entity, determined from the power regulation coefficient, to be commensurately greater when said temperature deviation of the consuming entity is low.

3. Method according to claim 1, wherein the steps a) to d) are reiterated until the electrical power demanded by the set of consuming entities is less than or equal to the setpoint power.

4. Method according to claim 1, wherein execution of the steps a) to d) is triggered on reception of a command from the network.

5. Method according to claim 1, wherein each entity receives, in real time, the overall power consumed by the set of consuming entities, from the network.

6. Method according to claim 1, wherein the power regulation coefficient is determined by a computation method based on fuzzy logic.

7. Method according to claim 6, wherein the determination of the power regulation coefficient comprises
a first substep of fuzzification during which the first power deviation datum is translated into degree(s) of membership to one or more subsets which characterize a first component of contribution of the entity to a reduction of overall power consumption;
a second substep of fuzzification during which the second temperature deviation datum is translated into degree(s) of membership to one or more subsets which characterize a second component of contribution of the entity to the reduction of overall power consumption;
a third substep of inference during which, from the results of the first and second substeps of fuzzification and from predefined inference rules, at least one degree of membership to one or more subsets which characterize the power regulation coefficient is determined;
a fourth substep of defuzzification during which a numeric regulation coefficient value is determined from the results of the substep of defuzzification.

8. Method according to claim 1, wherein the consuming entities are equipped with at least one of the thermal installations from the group comprising an electrical atmospheric heating installation, an electric water heater and an electrical atmospheric air conditioning installation.

9. Method according to claim 1, wherein the temperature of the entity regulated by the thermal installation is an atmospheric temperature in a building or a heated water temperature.

10. Device for regulating the electricity consumption of a consuming entity linked to an electrical network, adapted to implement the method according to claim 1, said entity comprising a thermal installation consuming electricity and intended to regulate a temperature of the entity and membership to a set of consuming entities, said device comprising:
a first communication module adapted to receive an overall electrical power consumed by said set of entities (E1, . . . , EN) and a setpoint power, from the electrical network;
a second communication module adapted to receive a temperature of the entity measured at a given instant;
a module for determining a first datum representative of a deviation between the overall electrical power consumed at a given instant and a setpoint electrical power;
a module for determining a second datum representative of a temperature deviation between a measured temperature of the entity for the instant considered and a reference temperature of the entity;
a module for determining a power regulation coefficient for the entity from the first power deviation datum and the second temperature deviation datum;
a control module intended to control a reduction of the power consumed by the thermal installation of the consuming entity dependant on the determined regulation coefficient.

11. Computer program comprising program code instructions for the execution of the steps of the method according to claim 1, when said program is run on a computer.

12. Method according to claim 4, wherein the command from the network contains a setpoint power.

13. Method according to claim 2, wherein the steps a) to d) are reiterated until the electrical power demanded by the set of consuming entities is less than or equal to the setpoint power.

14. Method according to claim 2, wherein execution of the steps a) to d) is triggered on reception of a command from the network.

15. Method according to claim 2, wherein each entity receives, in real time, the overall power consumed by the set of consuming entities, from the network.

16. Method according to claim 2, wherein the power regulation coefficient is determined by a computation method based on fuzzy logic.

17. Method according to claim 16, wherein the determination of the power regulation coefficient comprises
a first substep of fuzzification during which the first power deviation datum is translated into degree(s) of membership to one or more subsets which characterize a first component of contribution of the entity to a reduction of overall power consumption;
a second substep of fuzzification during which the second temperature deviation datum is translated into degree(s) of membership to one or more subsets which characterize a second component of contribution of the entity to the reduction of overall power consumption;
a third substep of inference during which, from the results of the first and second substeps of fuzzification and from predefined inference rules, at least one degree of membership to one or more subsets which characterize the power regulation coefficient is determined;
a fourth substep of defuzzification during which a numeric regulation coefficient value (is determined from the results of the substep of defuzzification.

18. Method according to claim 2, wherein the consuming entities are equipped with at least one of the thermal installations from the group comprising an electrical atmospheric heating installation, an electric water heater and an electrical atmospheric air conditioning installation.

19. Method according to claim 2, wherein the temperature of the entity regulated by the thermal installation is an atmospheric temperature in a building or a heated water temperature.

20. Method according to claim 14, wherein the command from the network contains a setpoint power.
